(19) United States
(12) Patent Application Publication
(10) Pub. No.: US 2024/0315313 A1
(43) Pub. Date: Sep. 26, 2024

(54) CIGARETTE ROLLING MACHINE

(71) Applicant: Zhu JIN, Yichun City (CN)

(72) Inventor: Zhu JIN, Yichun City (CN)

(21) Appl. No.: 18/402,712

(22) Filed: Jan. 2, 2024

(30) Foreign Application Priority Data
Mar. 20, 2023 (CN) 202320546648.3

(51) Int. Cl. A24C 5/44

(52) U.S. Cl. CPC A24C 5/44; F16H 1/04

(57) ABSTRACT

A cigarette rolling machine includes a first supporting shell, a second supporting shell is pivotally connected to a top of the first supporting shell; cigarette rolling components are uniformly provided in the first and the second supporting shell; each of the cigarette rolling components includes a cigarette roller, a rotating shaft and a driven gear; the rotating shaft is connected with the first supporting shell in a sliding way and one end of the rotating shaft is fixedly connected with the driven gear. Tobacco leaves entering between the first and the second supporting shell are rolled into a cylindrical shape through the cigarette rolling components, a rotating component is arranged at one end of the first supporting shell, the cigarette rolling components are driven to rotate through rotation of the rotating component and cigarette paper is put into the cigarette rolling components through open slots to wrap the tobacco leaves.

### CROSS-REFERENCE TO RELATED APPLICATIONS

This application claims priority of Chinese Utility Model Patent Application No. 202320546648.3, filed on Mar. 20, 2023, the entire contents of which are incorporated herein by reference.

### FIELD OF THE INVENTION

The application relates to the technical field of cigarette equipment, and in particular to a cigarette rolling machine.

### BACKGROUND

As the world's largest consumer of cigarettes, China's total number of smokers accounts for one-third of the world's total. For the tobacco consumer group, although there are many cigarette brands, it is still difficult to meet people's different needs for cigarette flavors. Therefore, smokers use cigarette rolling machines to roll cigarettes themselves to meet their different cigarette needs, such as manual and automatic cigarette rolling machines.

For example, CN201520915632.0 discloses a manual cigarette rolling device, which solves the technical problems that when the cigarette tube drives the tobacco to separate from the tobacco guide groove, part of the tobacco remains in the tobacco guide groove and cannot smoothly slide into the cigarette tube, resulting in insufficient tobacco in the cigarette tube and low cigarette quality.

When using the above technology, people encountered the following technical problems: existing manual cigarette rolling machines are prone to producing defective products in shape during use. Therefore, the invention provides a cigarette rolling machine to solve the above problems.

### SUMMARY OF THE INVENTION

An objective of the application is to provide a cigarette rolling machine. In the cigarette rolling machine, a second supporting shell is pivotally connected to the top of a first supporting shell, tobacco leaves are prevented from running out through the closure of the first supporting shell and the second supporting shell, cigarette rolling components are uniformly arranged inside the first supporting shell and the second supporting shell, tobacco leaves entering between the first supporting shell and the second supporting shell are rolled into a cylindrical shape through the cigarette rolling components, a rotating component is arranged at one end of the first supporting shell, the cigarette rolling components are driven to rotate through the rotation of the rotating component, and at the same time, cigarette paper is put into the cigarette rolling components through the open slots to wrap the tobacco leaves.

To achieve the above objective, the present application adopts a following technical scheme.

A cigarette rolling machine includes a first supporting shell, wherein a second supporting shell is pivotally connected to a top of the first supporting shell, and cigarette rolling components for assisting cigarette rolling are uniformly provided in the first supporting shell and the second supporting shell.

Each of the cigarette rolling components includes a cigarette roller, a rotating shaft and a driven gear, wherein the rotating shaft is connected with the first supporting shell in a sliding way, one end of the rotating shaft is fixedly connected with the driven gear, and the cigarette roller is fixed at another end the rotating shaft and located in the first supporting shell.

In an embodiment, the first support shell and the second support shell are both provided with open slots at opening and closing positions.

In an embodiment, an outer side of the cigarette roller is uniformly provided with cigarette rolling grooves.

In an embodiment, one end of the first supporting shell is provided with a rotating component for driving the driven gear.

In an embodiment, the rotating component includes a rotating disk, a positioning bolt and a driving gear, wherein the positioning bolt is rotatably connected with the first supporting shell, the driving gear is provided at an outer side of the positioning bolt and the one end of the first supporting shell, the driving gear is meshed with the driven gear, and the driving gear is fixedly connected with the rotating disk.

In an embodiment, anti-skid grooves are uniformly fixed on an outer side of the rotating disk.

In an embodiment, a bottom of the first supporting shell is provided with observation windows.

Undoubtedly, the above-mentioned cigarette rolling machine will solve the technical problem in the prior art.

The embodiments have the following advantages.

In the cigarette rolling machine provided by the application, a second supporting shell is pivotally connected to the top of a first supporting shell, tobacco leaves are prevented from running out through the closure of the first supporting shell and the second supporting shell, cigarette rolling components are uniformly arranged inside the first supporting shell and the second supporting shell, tobacco leaves entering between the first supporting shell and the second supporting shell are rolled into a cylindrical shape through the cigarette rolling components, a rotating component is arranged at one end of the first supporting shell, the cigarette rolling components are driven to rotate through the rotation of the rotating component, and at the same time, cigarette paper is put into the cigarette rolling components through the open slots to wrap the tobacco leaves.

By matching the rotating disk, positioning bolt and driving gear, the positioning bolt is connected to the first supporting shell in a sliding way, and the positioning bolt may rotate in the first support shell. Moreover, one end of the positioning bolt is fixed to one end of the driving gear, and the rotating disk is fixed at the other end of the driving gear. The rotation of the rotating disk drives the driving gear to rotate, and anti-skid grooves are used to prevent hand slipping when rotating the rotating disk. Further, cigarette rolling components are driven to rotate by the rotation of the driving gear.

By matching the cigarette rollers, rotating shafts and driven gears, the rotation of the driving gears drives the driven gears meshed with the driving gears to rotate, the rotation of the driven gears drives the rotating shafts to rotate, the rotation of the rotating shafts drives the cigarette rollers to rotate, and the tobacco leaves are rolled into a cylindrical shape by the rotation of the cigarette rollers.

### BRIEF DESCRIPTION OF THE DRAWINGS

In order to explain the technical scheme of the embodiment of the application more clearly, the drawings needed in the description of the embodiment will be briefly introduced below. Obviously, the drawings in the following description are some embodiments of the application. For ordinary people in the field, other drawings may be obtained according to these drawings without creative work.

FIG. 1 is a schematic diagram of an overall structure of the application, in accordance with embodiments of the invention.

FIG. 2 is an upward view of the present application, in accordance with embodiments of the invention.

FIG. 3 is a schematic diagram of the cigarette rolling machine in open state, in accordance with embodiments of the invention.

FIG. 4 is a schematic diagram of the internal structure of the first supporting shell of the present application, in accordance with embodiments of the invention.

FIG. 5 is a schematic structural diagram of the driving gear of the present application, in accordance with embodiments of the invention.

FIG. 6 is a schematic structural diagram of the rotating shaft of the present application, in accordance with embodiments of the invention.

### DETAILED DESCRIPTION

In order to make the objective, technical scheme and advantages of this application more clear, the application will be further described in detail with the attached drawings and embodiments. It should be understood that the specific embodiments described herein are only used to explain the application and are not used to limit the application.

As mentioned in the background, the existing manual cigarette rolling machine is prone to producing defective products in shape when it is used.

In order to solve the problem, the application provides a cigarette rolling machine.

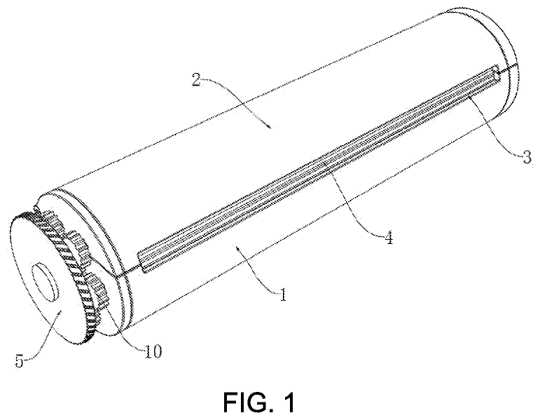

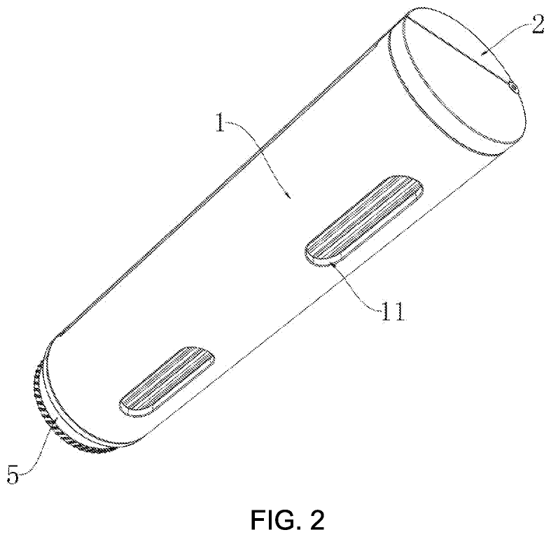

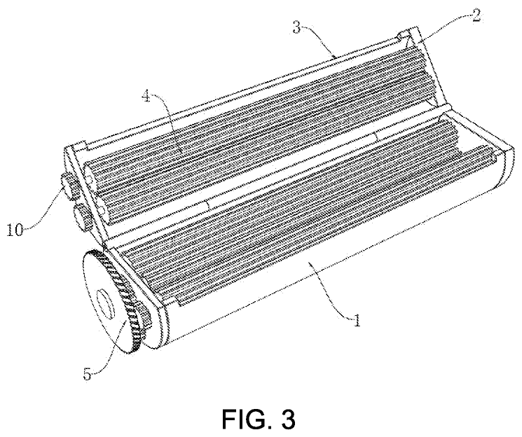

Referring to FIG. 1 to FIG. 3, the cigarette rolling machine includes:
a first supporting shell 1, where the top of the first supporting shell 1 is pivotally connected with a second supporting shell 2, the first support shell 1 and the second support shell 2 are both provided with open slots 3 at opening and closing positions for allowing cigarette paper to enter the insides of the first supporting shell 1 and the second supporting shell 2 through the open slots 3 to wrap tobacco leaves;
cigarette rolling components uniformly arranged in the first supporting shell 1 and the second supporting shell 2; and
a rotating component located at one end of the first supporting shell 1 and at the center of the cigarette rolling components, and used for driving the cigarette rolling components to rotate.

The cigarette rolling machine provided by the application is characterized in that a second supporting shell 2 is pivotally connected to the top of a first supporting shell 1, tobacco leaves are prevented from running out through the closure of the first supporting shell 1 and the second supporting shell 2, cigarette rolling components are uniformly arranged in the first supporting shell 1 and the second supporting shell 2, tobacco leaves entering between the first supporting shell 1 and the second supporting shell 2 are rolled into a cylindrical shape through the cigarette rolling components, a rotating component is arranged at one end of the first supporting shell 1, the cigarette rolling components are driven to rotate through the rotation of the rotating component, and at the same time, cigarette paper is put into the cigarette rolling components through the open slot 3 to wrap the tobacco leaves.

In order to make people in the technical field better understand the scheme of this application, the technical scheme in the embodiment of this application will be described clearly and completely with the attached drawings.

In the description of this application, it should be understood that the terms “center”, “vertical”, “horizontal”, “length”, “width”, “thickness”, “top”, “bottom”, “front”, “back”, “left”, “right”, “vertical”, “horizontal”, “top”, “bottom”, “inside”, “outside”, “clockwise”, “counterclockwise”, “axial”, “radial” “circumferential”, etc. indicate the orientation or position relationship based on the orientation or position relationship shown in the drawings, and are only for the convenience of describing and simplifying the description of this application, rather than indicating or implying that the device or component referred to must have a specific orientation, be constructed and operated in a specific orientation, and therefore cannot be understood as a limitation of this application. In addition, the terms “first” and “second” are only used to describe the purpose and cannot be understood as indicating or implying relative importance or implying the quantity of technical features indicated. Therefore, the features limited to “first” and “second” may explicitly or implicitly include at least one of these features. In the description of this application, “a plurality of” means at least two, such as two, three, etc., unless otherwise specified.

It should be noted that the embodiments and the features and technical solutions in the embodiments of this application may be combined with each other.

It should be noted that similar labels and letters represent similar terms in the following figures. Therefore, once a term is defined in one figure, it does not need to be further defined or explained in subsequent figures.

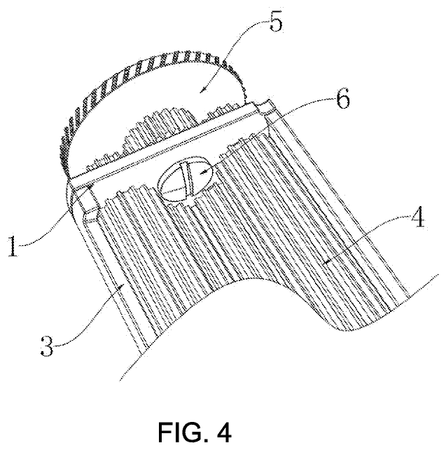

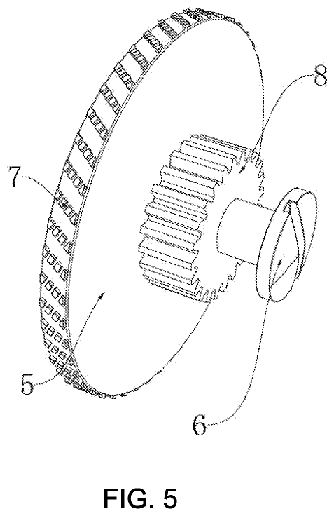

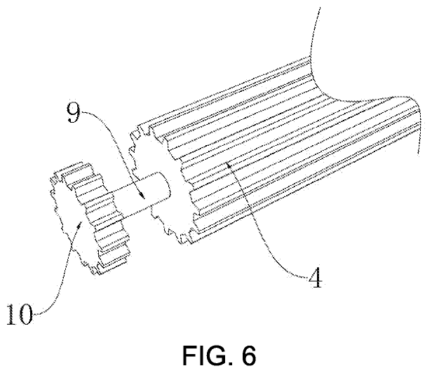

Referring to FIG. 1 to FIG. 6, a cigarette rolling machine includes a first support shell 1, observation windows 11 are provided in the bottom of the first support shell 1, and through the observation windows 11 the condition inside the first support shell 1 may be observed; the top of the first support shell 1 is pivotally connected to the second support shell 2, the first support shell 1 is pivotally connected to the second support shell 2 through hinges, allowing the first support shell 1 and the second support shell 2 to be opened and closed through the pivotal connection. The first support shell 1 and the second support shell 2 are both provided with open slots 3 at opening and closing positions, allowing the cigarette paper to enter the insides of the first support shell 1 and the second support shell 2 through the open slots 3 to wrap the tobacco leaves; cigarette rolling components for assisting cigarette rolling are uniformly provided in the first supporting shell 1 and the second supporting shell 2.

In this embodiment, six cigarette rolling components are provided, two of the cigarette rolling components are located in the second support shell 2, the remaining four of the cigarette rolling components are all located in the first support shell 1, and the six cigarette rolling components in the first support shell 1 and the second support shell 2 are uniformly distributed in a circular shape.

Each of cigarette rolling components includes a cigarette roller 4, a rotating shaft 9, and a driven gear 10. The rotating shaft 9 is connected to the first support shell 1 in a sliding way, the shape of the rotating body of the rotating shaft 9 makes it easy for the rotating shaft 9 to rotate in the first support shell 1, and the rotating shafts 9 located in the second support shell 2 may also slide and rotate with the second support shell 2. One end of the rotating shaft 9 is fixedly connected with a driven gear 10, and driven gears 10 in each of the cigarette rolling components are not in contact with each other. In the first support shell 1, cigarette rollers 4 are fixed at ends of the rotating shafts 9 and located in the first supporting shell 1; in the second supporting shell 2, the cigarette rollers 4 are also fixed at ends of the rotating shafts 9 and located in the second supporting shell 2; and cigarette rollers 4 in each of the cigarette rolling components are not in contact with each other, but the distance between two adjacent cigarette rollers 4 is close, and each of the cigarette rollers 4 is uniformly provided with cigarette rolling grooves on the outer sides for driving tobacco leaves to roll.

One end of the first support shell 1 is provided with a rotating component for driving the driven gear 10, and the rotating component is located at the center of a plurality of cigarette rolling components and drives the cigarette rolling components to rotate. The rotating component includes a rotating disk 5, a positioning bolt 6, and a driving gear 8. The positioning bolt 6 is rotatably connected to the first support shell 1, and may slide in the first supporting shell 1. The driving gear 8 is provided at an outer side of the positioning bolt 6 and at one end of the first supporting shell 1, and the positioning bolt 6 and the driving gear 8 are in interference fit connection, so that the positioning bolt 6 and the driving gear 8 may be firmly connected.

The driving gear 8 is meshed with the driven gears 10, so that the driven gears 10 are driven to rotate by the rotation of the driving gear 8; the driving gear 8 is fixedly connected with the rotating disk 5, so that the driving gear 8 is driven to rotate by the rotation of the rotating disk 5; anti-skid grooves 7 are uniformly fixed on the outer side of the rotating disk 5 for allowing the rotating disk 5 to increase friction with the hands and reduce slipping during rotation.

The use process of the cigarette rolling machine provided in the application is as follows: when in use, the first support shell 1 and the second support shell 2 are opened through a pivotal connection between the first support shell 1 and the second support shell 2, so that there is no closure between the first support shell 1 and the second support shell 2. Then, the tobacco leaves to be rolled are placed between the cigarette rollers 4 of the cigarette rolling components, and the first support shell 1 and the second support shell 2 are closed by the pivotal connection. The driving gear 8 is driven to rotate by rotating the rotating disk 5. The driving gear 8 rotates steadily at one end of the first support shell 1 by positioning bolt 6. The driven gears 10 meshing with the driving gear 8 are simultaneously driven to rotate in the same direction by the rotation of the driving gear 8. The rotation of the driven gears 10 drives the rotation of the rotating shafts 9, and the rotation of the rotating shafts 9 drives the rotation of the cigarette rollers 4, thereby quickly forming cylindrical shaped tobacco leaves through the forward and reverse rotation of the rotating disk 5. Then, the first support shell 1 and the second support shell 2 are opened again, and the cigarette paper is placed between the cigarette rolling components on the first support shell 1 and the cigarette rolling components on the second support shell 2. Then the first support shell 1 and the second support shell 2 are closed, so that the cigarette paper is located on the inner side of the open slots 3. Then, the rotating disk 5 is rotated in one direction, so that the cigarette rollers 4 drives the cylindrical shaped tobacco leaves and cigarette paper to wrap. Then, the inner side of the last position of the cigarette paper is coated with adhesive and then the rotating disk 5 is continuously rotated, so that the cigarette paper wraps the cylindrical shaped tobacco leaves; and then the first support shell 1 and the second support shell 2 are opened to take out the rolled cigarettes.

The above shows and describes the basic principles, main features, and advantages of the present application. Technicians in this industry should understand that this application is not limited by the aforementioned embodiments. The aforementioned embodiments and instructions only describe the principles of this application. Without departing from the spirit and scope of this application, there may be various changes and improvements in this application, all of which fall within the scope of the requested protection. The scope of protection required by this application is defined by the attached claims and their equivalents.

The claimed invention is:

1. A cigarette rolling machine, comprising a first supporting shell, wherein a second supporting shell is pivotally connected to a top of the first supporting shell, and cigarette rolling components for assisting cigarette rolling are uniformly provided in the first supporting shell and the second supporting shell;
each of the cigarette rolling components comprises a cigarette roller, a rotating shaft and a driven gear, wherein the rotating shaft is connected with the first supporting shell in a sliding way, one end of the rotating shaft is fixedly connected with the driven gear, and the cigarette roller is fixed at another end of the rotating shaft and located in the first supporting shell.

2. The cigarette rolling machine according to claim 1, wherein the first support shell and the second support shell are both provided with open slots at opening and closing positions.

3. The cigarette rolling machine according to claim 1, wherein an outer side of the cigarette roller is uniformly provided with cigarette rolling grooves.

4. The cigarette rolling machine according to claim 1, wherein one end of the first supporting shell is provided with a rotating component for driving the driven gear.

5. The cigarette rolling machine according to claim 4, wherein the rotating component comprises a rotating disk, a positioning bolt and a driving gear, wherein the positioning bolt is rotatably connected with the first supporting shell, the driving gear is located outside of the positioning bolt and at the one end of the first supporting shell, the driving gear is meshed with the driven gear, and the driving gear is fixedly connected with the rotating disk.

6. The cigarette rolling machine according to claim 5, wherein anti-skid grooves are uniformly fixed on an outer side of the rotating disk.

7. The cigarette rolling machine according to claim 1, wherein a bottom of the first supporting shell is provided with observation windows.
